(19) United States
(12) Patent Application Publication
(10) Pub. No.: US 2009/0322762 A1
(43) Pub. Date: Dec. 31, 2009

(54) Animated performance tool

(76) Inventors: Oliver Ilagan, Nashville, TN (US); Justin Bird, Nashville, TN (US)

Correspondence Address: BRENDAN BABCOCK, 1814 Rock Springs Road, Columbia, TN, 38401, US

(21) Appl. No.: 12/456,617

(22) Filed: Jun. 19, 2009

Related U.S. Application Data
(60) Provisional application No. 61/132,467, filed on Jun. 19, 2008.

(51) Int. Cl. G06T 15/70

(52) U.S. Cl. 345/473

(57) ABSTRACT

A performance tool comprises a program that configures metrics into animated scenarios and at least one display that displays the animated scenarios. The animated scenarios illustrate measurable inputted data from multiple sets of data that are juxtaposed with one another.

### CROSS-REFERENCE TO RELATED APPLICATIONS

This is a non-provisional application claiming priority to provisional patent application No. 61/132,467 filed on Jun. 19, 2008.

### STATEMENT REGARDING FEDERALLY SPONSORED RESEARCH

Not Applicable

### FIELD OF THE INVENTION

This invention relates to a method or apparatus for configuring, converting, animating, and/or broadcasting any individuals or organizations productivity, sales, and/or metrical performance during a set period of time.

### BACKGROUND OF THE INVENTION

There are many ways in which an organization can seek to improve the performance and/or productivity of its members and/or teams. One such way has been providing charts or graphs illustrating each team or member's performance. These graphs can be effective for some, but are not interactive or particularly engaging. A tool that presents selected performance metrics of members in an updated and animated manner can serve as a greatly improved motivational tool. There is a need for a performance tool that displays selected performance metrics that are engaging and interactive. This need can be filled by the instant invention. The art referred to and/or described within this application is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In at least one embodiment, the performance tool configures, animates, and/or broadcasts individual, team, site, and/or company level metrics in the form of animated scenarios. These scenarios can then be viewed at least on each screen of a participant, manager, administrator, and/or owner. In some embodiments the animated scenarios are displayed on a central public screen. In at least one embodiment these scenarios include competitions or races. An animated scenario based on selected metrics is often called a dash. The scenarios can include avatars of the participants competing against one another. In some embodiments the participants can add text or audio messages (e.g. trash talk) from their avatar. In some embodiments the messages and/or text are of a more instructive nature (e.g. performance tips, news, work experiences, plans, meetings, etc.)

At least one embodiment of this invention can capture an organization's or team's metrics or data, combine it with a desired goal or outcome, and convert them all into an animated representation of each participant's performance. In at least one embodiment the invention can select and configure a pre-designed competition on a website and/or computer interface and enter in information regarding number of participants, competition parameters, and goal(s) to win the competition. Members can then customized their individual characters which are presented and broadcasted in an animated competition format. Data can be manually entered or directly linked to a data feed. In some embodiments the administrator is responsible for entering the data. In some embodiments, due to the frequency of new data and the duration of the competition, directly linking to a data feed better animates and updates the competition, portrays current and previous status of performance, allows the competition's administrators to define prize or prizes for the winner(s), and allows user defined communications or tips on how to improve performance.

In some embodiments, the performance tool is used at call centers to improve performance and productivity. In some embodiments, the performance tool is used for fund raising (for non-profits or for profits).

In some embodiments the performance tool is used in athletic and/or physical endeavors; members at a health club or a team can compete and drive each other to make better improvements in strength, speed, endurance, performance (during the activity or sport), and/or fat or weight loss to name a few.

These and other embodiments which characterize the invention are pointed out with particularity in the claims annexed hereto and forming a part hereof However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a flowchart of the performance tool from Account set-up to results or denouement

FIGS. 2-6 are schematic views of various screens embodied in the invention.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated. It should be noted that the term “member(s)” can include participant, manager, administrator, and/or owner.

In some embodiments, the performance tool involves multiple members with different roles. These roles can include participant, manager, administrator, owner, observer, wallboard, and coach.

In some embodiments a participant can manage their profile, view metric data and/or performance for current and historical dashes, and/or make comments/interact with other participants in dashes in progress. In some embodiments a participant can manage personal information such as first/last name, email address, create/customize dash avatar, etc.

In some embodiments a manager can possess all a participant's abilities, enter/update metrical data for dashes assigned to them, create dashes (e.g. configuring dash rules/criteria, designate/post prize information, choose dash theme, set start/finish dates and number of data intervals), manage participants for dashes assigned to them, and/or manage messages and communications for dashes assigned to them (e.g. edit/remove dash comments, manage/edit dashboard communications).

In some embodiments an administrator can have the manager's abilities, assign a manager to a dash, and/or manage all users and set the users' roles.

In some embodiments an owner (sometimes referred to as the Master Administrator) can have the administrator's abilities and purchase licenses In some embodiments an observer can manage their profile including managing personal info such as first/last name, email address, and/or create/customize dash avatar. The observer can also make comments during the dash and/or view dash animations, rules, prize, etc.

In some embodiments the invention includes a wallboard which displays a looping dash animation. In some embodiments the looping dash animation switches or fades from one screen image to another. In some embodiments the looping dash animations can act as a screen saver at times. The screen images can include: a screen that displays the time elapsed since the beginning of the dash, a screen that displays the current state of the dash showing participants positions and in some instances including communication bubbles emitting from the participants' avatars, a screen that displays the leader profile including information on the leader or leaders (e.g. 1^{st}, 2^{nd}, 3^{rd}), and a screen that displays the Dashboard which can be a screen that acts as a vehicle for communication in which any dash member outside of an observer or participant can add and/or change information on the screen. This information can comprise performance tips, evaluations of performance, quotes, encouragement, etc. In some embodiments, the wallboard has no administration/managing rights. It should also be noted that the looping dash animation can also run on the individual screens of each participant.

In some embodiments a coach can manage personal info (e.g. first/last name, email address, create/customize dash avatar), make comments/interact with other participants in dashes in progress, and/or manage content on Dashboard bulletin board.

It should also be noted that these roles are not static; any individual can have different roles on different dashes (e.g. participant in one dash, observer in another, and a coach in yet another . . . etc).

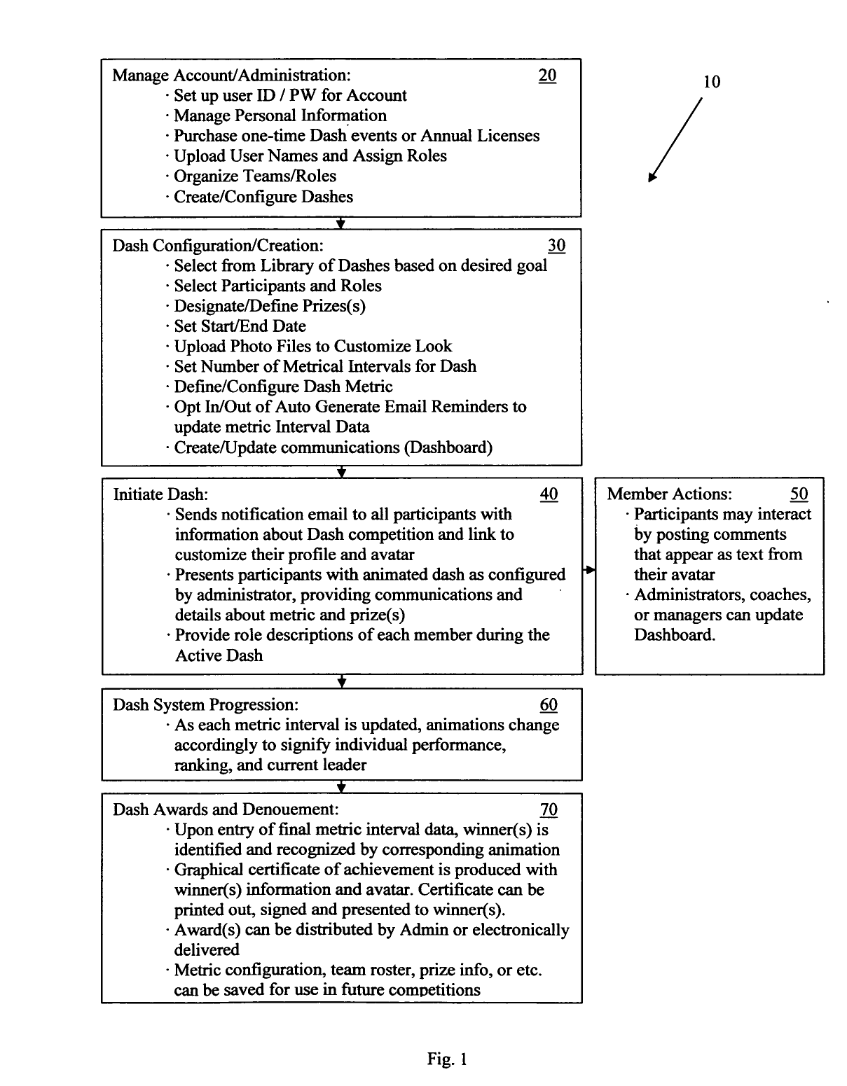

In some embodiments the performance tool can be administered, configured, and have a theme selected as shown in the flowchart 10 of FIG. 1. In the Manage Account Box 20 various tasks are listed for setting up the administration of a dash. In some embodiments the dash is purchased as a one-time event or, as an alternative, an annual license can be purchased. In some embodiments, hybrid roles be created that combine at least one role definitions of one role with at least one different one of another. In some embodiments a database of participants can be imported and/or configured to be used with the performance tool.

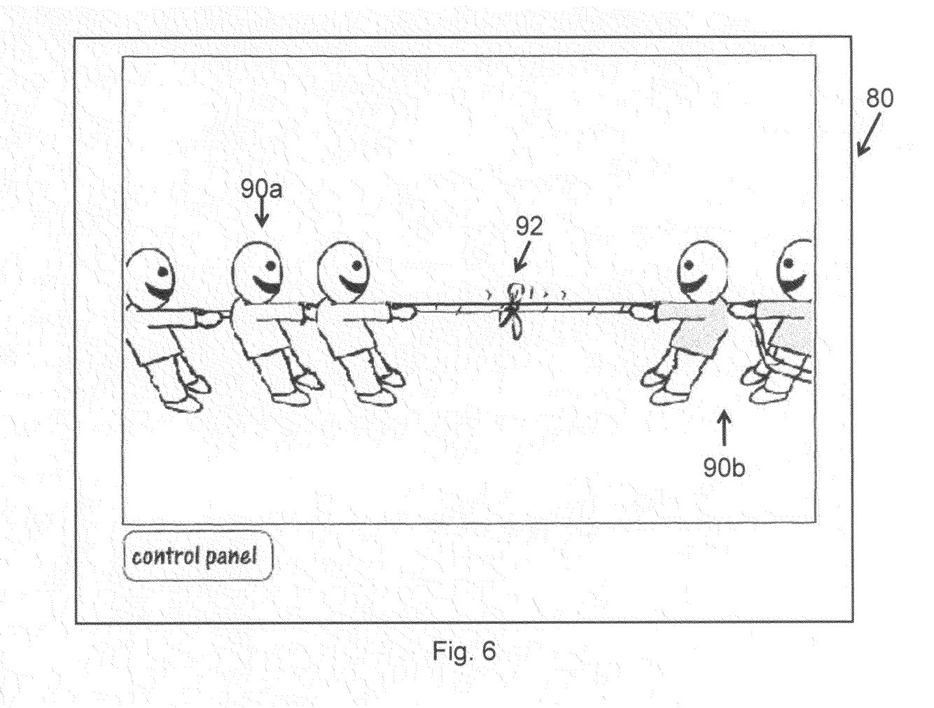

In the Dash Configuration Box 30 tasks are listed for creating and configuring the dash. In some embodiments there is a library of dashes which includes dashes for individual participants or groups (e.g. individual participant's competitions, intra-team competitions, manager competitions, etc.). In some embodiments the scenarios in which the dash are being conducted are that of a race or an accumulation of a good (e.g. an outer space theme, a track theme, building a tower, etc.). In some embodiments the scenarios are that of avoiding or staying in front of something, perhaps a deadline or dropped calls, (i.e. running of the bulls scenario). Other scenarios include those for a dual competition containing two competing participants or groups (e.g. tug-of-war, teeter-totter, boxing, wrestling, etc.). An example of a scenario having a dual competition in which the dash animation is updated by measuring the difference between the two competing participants/teams is shown in FIG. 6. Here, the tug-of-war scenario 80 is shown. In some embodiments, the dash is updated in this scenario 80 by measuring the relevant metric(s) of both participants/teams 90 and subtracting one participant's metric from that of the other such that the rope and rope marker 92 will move in the direction of the better performing participant.

In some embodiments, the configuration of the performance tool can include the option of uploading photo files to customize the look of the dash. These photo files can include company/team logo or pictures of prize(s). During the performance tool configuration 30 the number of metrical intervals for the dash is set. The movements and/or progression of dash animation are, in many embodiments, directly correlated to the frequency and intervals of the data supplied by user (real-time database feed, hourly, daily . . . etc). In some embodiments the intervals are smaller and thus changes in the dash animation are more pronounced (e.g. a dash including an interval for each call made would have greater changes). In other embodiments the intervals are larger and thus the changes are recognized more slowly (e.g. a dash including an interval of 10 calls). In some embodiments the metric data supplied comes from a database feed which can provide a real time measure of performance. In some embodiments, the metrics are entered by hand. In some embodiments the metrics are entered anywhere from every fraction of a second (as technology allows) to every hour to every day or every week or longer. In some embodiments the metrics are entered anywhere from every second to every few seconds to every minute to every hour to every day or every week or longer.

In some embodiment during the dash configuration, the dash metric must be defined and/or configured such that the metric being measured is understood and whether a higher or lower (positive or negative) value is better.

In some embodiments during the dash configuration, additional metrics can be defined. In some embodiments dash tie breakers may be determined by an additional metric.

In some embodiments the performance tool generates email reminders to update metric interval data. In some embodiments, a “dashboard” can be created to update communications between participants and/or administrator.

In some embodiments the performance tool stores, perhaps in a library, previously configured themes/scenarios, dashboard, prizes, metric, and groups of participants or other members of the dash such that an administrator can pick or match from the library to create a new dash.

Actions that can be included to initiate a Dash are shown in the Initiate Dash Box 40. In some embodiments the performance tool sends a notification to members involved in the dash (e.g. notification can be an email). In some embodiments the notification includes information about dash competition such as start and end dates and/or a link for each member to their profile and/or avatar. In some embodiments, the notification is sent at the time a dash is to commence; in some embodiments the notification lets members of the dash know of a future start date for a dash. Other information that can be provided in different embodiments are role descriptions of each member during an active dash.

Members of the dash can perform various actions such as leaving a comment that emanates from their avatar. In some embodiments, some members (e.g. administrators, coaches, and/or managers) can update the dashboard. In some embodiments the participants can also update the dashboard.

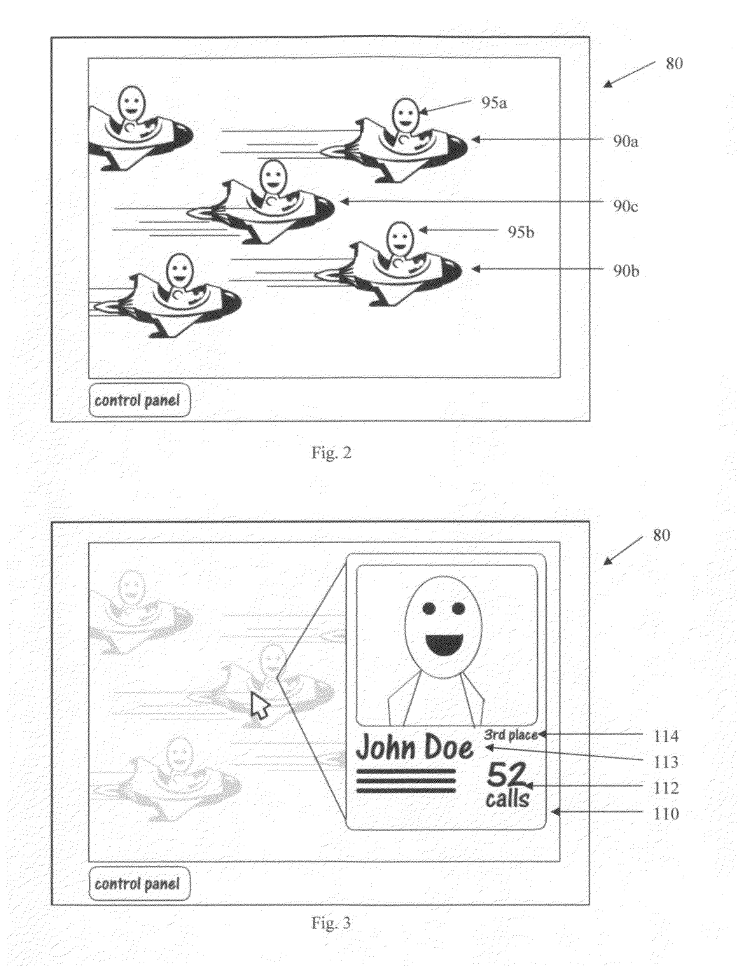

In some embodiments the notification presents participants with an animated dash as configured by the administrator and provides communications and details about metric and prize(s). In FIG. 2 an animated dash scenario 80 is shown (it should be noted that this scenario is only used for example purposes as there are many other animated scenarios that have been contemplated and can be used). In FIG. 2 each spaceship/driver 90 represents a participant in the dash. In this dash scenario 80 the spaceship/driver 90 are located in their respective positions based on the performance of each participant. At this point in the dash the participants represented by 90a and 90b have a higher performance than the other spaceships (e.g. 90c). The positions of each spaceship participant 90 can change based on the data input into the performance tool. The spaceship/driver avatar 90 can also include a face photograph 95 of each participant that is also uploaded in the performance tool. This can be done and/or edited by the administrator and/or participant.

The actual performance data used in the dash can be displayed. In some embodiments moving the cursor 100 over each spaceship/participant 90 as shown in FIG. 3 displays the performance data window 110. The performance metric 112, the name 113 of the participant and position 114 in the dash can also be displayed as represented in FIG. 3.

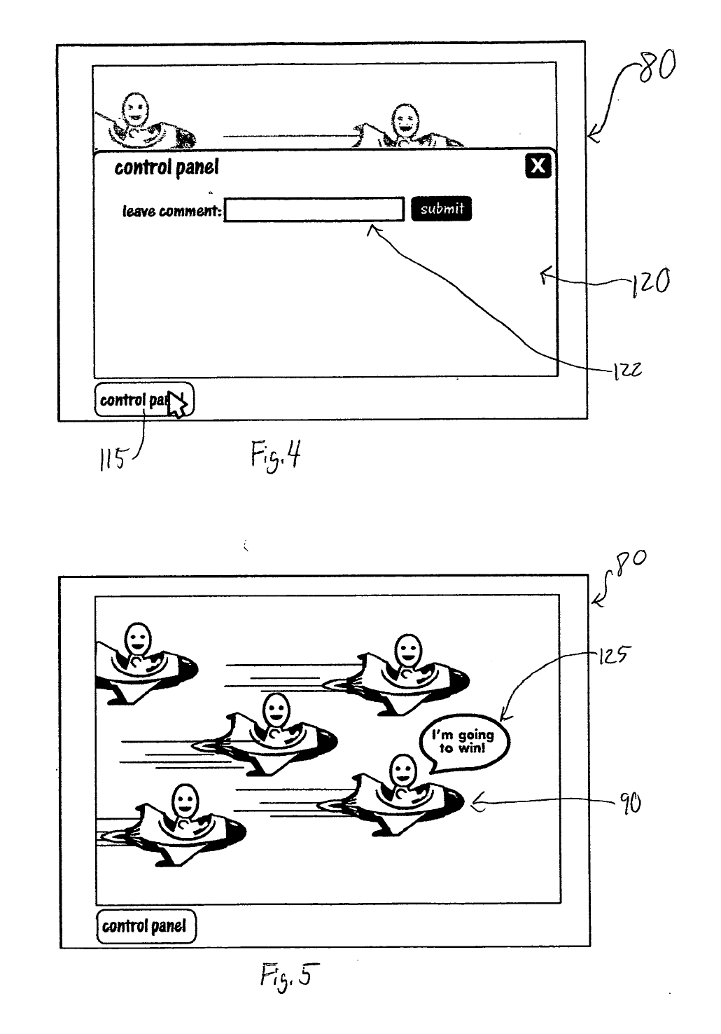

A control panel can also be displayed in some embodiments. FIG. 4 displays one manner of doing this. In FIG. 4 clicking on the control panel button 115 opens the control panel window 120. The control window can have various functions such as an option to change your avatar or uploaded picture. Here the control panel window 120 provides a comment line 122 in which to leave a comment. In some embodiments, the control panel window 120 allows you to upload an audio or video file.

As shown in FIG. 5, a text bubble 125 is displayed emanating from one of the participant avatars 90 as a result of entering a comment in the comment line 122 of control panel window 120 of FIG. 4. It should be noted that individualized avatars can be used. In some embodiments the avatar 90 can include a favorite vehicle (e.g. a '57 Chevy) whereas another participant avatar 90 can include a pick-up truck or the like. A dog lover might use a Greyhound. In some embodiments, members of the dash can upload an entire avatar rather than just a picture of themselves. In some embodiments the performance tool provides many avatars in which to choose from. In some embodiments a member of the dash can make an image of the member's features. In some embodiments any participating member of a dash can create an avatar/likeness/representation of themselves using an application which allows them to mix and match various components of a head to include eyes, nose, mouth, skin color, ears . . . etc.”

Again, referencing the flowchart 10 of FIG. 1, Dash System Progression Box 60 addresses how progression within the scenarios 80 occur. As each metric interval is updated, animations can change. This can result in changes in the current leader and the other participants' ranks. In some embodiments the performance data window 112 (see FIG. 3) also includes a momentum factor to represent a performance push that a participant has been making recently, but has not yet resulted in that individual having a large cumulative change. This is akin to measuring the acceleration rather than just the velocity of an individual's performance.

In some embodiments, the dash includes multiple scenarios. In some embodiments, teams compete in a tug-of-war scenario (see FIG. 6) while the individual participants of the teams compete in a space race scenario (see FIG. 2). In some embodiments, the dash includes multiple levels of competition wherein a first level of participants compete in one or more scenarios while another level of participants (e.g. the actual managers of the first level participants) compete in another group of one or more scenarios. The multiple levels of a dash can include scenarios for those participants at an entry level position all the way to scenarios for the top levels of an organization. In fact, in some embodiments, a Dash can include multiple organizations (e.g. different companies) competing in one or more scenarios.

Dash Awards and Denouement Box 70 addresses the end of the dash and that which follows. In some embodiments, upon entry of final metric interval data, a winner(s) is identified and recognized by corresponding animation. This identification can be the winner's name flashed on the dashboard or a confetti release or the like. In some embodiments, a graphical certificate of achievement can be produced with the winner(s) information and avatar. In some embodiments, a certificate can be printed out, signed and presented to winner(s). Award(s) can be distributed by Administrator or electronically delivered. In some embodiments, metric configuration, team roster, prize info, and/or etc. can be saved for use in future competitions.

In some embodiments, the performance tool is a stand alone machine that displays the results. In some embodiments the stand alone machine can be linked to participants' computers. In some embodiments, the performance tool can be hosted on a centralized set of computers or installed locally as a standalone application on an isolated computer network. In some embodiments, the performance tool may reside on a central set of computer servers and broadcasted via the internet to multiple locations and users. In some embodiments, various rules, animations or data can be incorporated into each competition to drive desired outcome. In some embodiments, competitions, animations, rules, and criteria can include but are not limited to any movement, criteria, sounds, music, text, objects, interactions, colors, and characters that assist in conveying the competition and driving desired outcomes. In some embodiments, the dashes are between individuals or groups within the same company. In some embodiments, the dashes are between companies.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A performance tool comprising a program that configures metrics into animated scenarios, at least one display that displays the animated scenarios, the animated scenarios illustrating measurable inputted data from multiple sets of data that are juxtaposed with one another.

2. The performance tool of claim 1 having different displays for different users.

3. The performance tool of claim 2 having different displays for different users selected from the group consisting of participant, manager, administrator, owner, and any combination thereof.

4. The performance tool of claim 1 having a display on a public screen.

5. The performance tool of claim 1 wherein the animated scenarios is a race.

6. The performance tool of claim 1 wherein avatars are used to represent the sets of data.

7. The performance tool of claim 6 wherein the sets of data include the performance metrics of single entities and/or groups.

8. The performance tool of claim 3 wherein text or audio messages can be inputted by one or more of the different users and displayed on one or more different displays.

9. The performance tool of claim 8 wherein the messages are from the group consisting of trash talk, performance tips, news, work experiences, plans, meetings, and any combination thereof.

10. The performance tool of claim 1 wherein the sets of data include performance goals and performance metrics of single entities and/or groups.

11. The performance tool of claim 1 wherein a pre-designed competition is selectable and/or configurable on a website and/or computer interface, configurable information includes number of participants, participant data, competition parameters, and/or at least one goal.

12. The performance tool of claim 1 wherein personal data is imputable by the user, the personal data includes avatar settings, age, position, one or more goals, and/or text.

13. The performance tool of claim 1 used in a call center, metrics measured are number of calls made, the number of successful calls, and/or the sale size from each call.

14. The performance tool of claim 1 data is directly linked to a data feed, the data feed updates the competition, portrays current status of performance, portrays previous status of performance, defines prizes, and/or allows performance tips.

15. The performance tool of claim 1 wherein performance is measured for users selected from the group consisting of health clubs, sports teams, centers of learning, classes for standardized tests, call centers, brokers, corporations, and any combination thereof.

16. The performance tool of claim I wherein the scenarios used are selected from the group consisting of space race, mountain climbing, track and field, and any combination thereof.

17. The performance tool of claim 1 wherein the metrics animated are the performance of at least one individual and at least one performance goal to be reached, the performance and goal being tracked in time segments selected from the group consisting of seconds, minutes, hours, days, weeks, months, years, and any combination thereof.

18. A performance tool comprising a program that configures metrics into animated scenarios, at least one display that displays the animated scenarios, the animated scenarios illustrating measurable inputted data from multiple sets of data that are juxtaposed with one another, the metrics including performance data of one or more individuals, the scenarios in which the sets of data are displayed include races, weight lifted, heights reached, or any combination thereof, avatars are used to represent each individual.
